(19) United States
(12) Patent Application Publication
(10) Pub. No.: US 2026/0032437 A1
(43) Pub. Date: Jan. 29, 2026

(54) AUTHENTICATION OF AMBIENT INTERNET OF THINGS (AIOT) DEVICES

(71) Applicant: Lenovo (United States) inc., Morrisville, NC (US)

(72) Inventors: Thomas Ralph LUETZENKIRCHEN, Munich (DE); Andreas KUNZ, Ladenburg (DE); Genadi VELEV, Darmstadt (DE)

(21) Appl. No.: 19/343,915

(22) Filed: Sep. 29, 2025

(51) Int. Cl. H04W 12/06; G16Y 30/10; H04W 12/69

(52) U.S. Cl. CPC H04W 12/06; G16Y 30/10; H04W 12/69

(57) ABSTRACT

Various aspects of the present disclosure relate to (e.g., authenticating, verifying, authorizing, validating) ambient Internet of Things (AIOT) devices identified by filtering information, permanent identifiers, T-IDs, and so on. For example, an AIoT data management (ADM) entity may perform group authentication of AIOT devices, where the ADM manages and updates a cache of previously authenticated AIOT devices (for group inventory procedures). The ADM may identify the previously authenticated AIOT devices using a session ID (e.g., one specific to an inventory procedure), a derivation parameter, or other parameters.

### TECHNICAL FIELD

The present disclosure relates to wireless communications, and more specifically to managing (e.g., authenticating, verifying, authorizing, validating) ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for managing (e.g., authenticating, verifying, authorizing, validating) AIoT devices. Additionally, the present disclosure relates to methods, apparatuses, and systems for managing (e.g., authenticating, verifying, authorizing, validating) AIoT devices during AIoT operations (e.g., inventory or command procedures), such as via group response caching and/or controlling (e.g., storing, handling, updating) temporary identifier lifecycles.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to receive a request for authentication of a group of AIoT devices during an AIoT operation, wherein the request includes a session identifier associated with the AIoT operation, filtering information, and a derivation parameter, identify one or more previously authenticated AIoT devices from the group of AIoT devices based at least in part on the session identifier or the derivation parameter, and authenticate one or more AIoT devices from the group of AIoT devices other than the identified one or more previously authenticated AIoT devices.

A method performed or performable by the network entity is described. The method may comprise receiving a request for authentication of a group of AIoT devices during an AIoT operation, wherein the request includes a session identifier associated with the AIoT operation, filtering information, and a derivation parameter, identifying one or more previously authenticated AIoT devices from the group of AIoT devices based at least in part on the session identifier or the derivation parameter, and authenticating one or more AIoT devices from the group of AIoT devices other than the identified one or more previously authenticated AIoT devices.

In some implementations of the network entity and method described herein, the request for authentication includes multiple response parameters (RES_{AIOT}) and corresponding derivation parameters (RAND_{AIOT_d}) for multiple AIoT devices, and wherein the network entity and method may further be configured to, capable of, performed, performable, or operable to authenticate the multiple AIoT devices in a single authentication operation.

In some implementations of the network entity and method described herein, for each received RES_{AIOT_d} and corresponding RAND_{AIOT_d}, the network entity and method may further be configured to, capable of, performed, performable, or operable to compute expected response values (XRES_{AIOT}) for one or more candidate AIoT devices, compare each RES_{AIOT} d with the computed XRES_{AIOT} values, and return information only identifying AIoT devices for which a match is found based on the comparison.

In some implementations of the network entity and method described herein, to identify the one or more previously authenticated AIoT devices, the network entity and method may further be configured to, capable of, performed, performable, or operable to transmit a query request to a unified data repository (UDR), wherein the query request comprises the session identifier and the derivation parameter, and receive, from the UDR, a query response that indicates one or more authenticated AIoT devices, wherein the one or more authenticated AIoT devices includes the one or more previously authenticated AIoT devices from the group of AIoT devices.

In some implementations of the network entity and method described herein, to identify the one or more previously authenticated AIoT devices, the network entity and method may further be configured to, capable of, performed, performable, or operable to determine, based at least in part on the session identifier and the derivation parameter, whether a group authentication cache entry exists for the group of AIoT devices in a cache associated with the UDR.

In some implementations of the network entity and method described herein, in response to an absence of the group authentication cache entry for the group of AIoT devices in the cache associated with the UDR, the network entity and method may further be configured to, capable of, performed, performable, or operable to create the group authentication entry for an inventory procedure associated with the group of AIoT devices, wherein the group authentication cache entry includes a new session identifier and timing information for retaining the group authentication cache entry.

In some implementations of the network entity and method described herein, the timing information for retaining the group authentication cache entry is based at least in part on a number of AIoT devices of the group of AIoT devices or the inventory procedure.

In some implementations of the network entity and method described herein, the session identifier is derived at least in part on the filtering information.

In some implementations of the network entity and method described herein, the network entity is an AIoT data management (ADM) entity.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to receive a request to perform an inventory procedure using a group of AIoT devices, identify, via a cache locally stored at the network entity, a list of previously authenticated AIoT devices from the group of AIoT devices, and transmit, to an ADM entity, a request to authenticate the group of AIoT devices excluding the list of previously authenticated AIoT devices.

A method performed or performable by the network entity is described. The method may comprise receiving a request to perform an inventory procedure using a group of AIoT devices, identifying, via a cache locally stored at the network network, a list of previously authenticated AIoT devices from the group of AIoT devices, and transmitting, to an ADM entity, a request to authenticate the group of AIoT devices excluding the list of previously authenticated AIoT devices.

In some implementations of the network entity and method described herein, the request to authenticate the group of AIoT devices includes multiple response parameters (RES_{AIOT_d}) and corresponding derivation parameters (RAND_{AIOT_d}) for multiple AIoT devices.

In some implementations of the network entity and method described herein, the network entity is an AIoT function (AIOTF).

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to receive a request from a network function for a temporary identifier (T-ID) associated with a permanent identifier of an AIoT device, wherein the request includes a T-ID handling type, retrieve a T-ID record from a data repository using the permanent identifier as a key, determine whether a T-ID exists for the AIoT device, in response to determining that no T-ID exists and the handling type indicates a stored T-ID, provision a new T-ID, and transmit the T-ID and the handling type to the network function for paging the AIoT device during an AIoT operation.

A method performed or performable by the network entity is described. The method may comprise receiving a request from a network function for a T-ID associated with a permanent identifier of an AIoT device, wherein the request includes a T-ID handling type, retrieving a T-ID record from a data repository using the permanent identifier as a key, determining whether a T-ID exists for the AIoT device, in response to determining that no T-ID exists and the handling type indicates a stored T-ID, provisioning a new T-ID, and transmitting the T-ID and the handling type to the network function for paging the AIoT device during an AIoT operation.

In some implementations of the network entity and method described herein, the network entity and method may further be configured to, capable of, performed, performable, or operable to receive a resynchronization request that includes a resynchronization indicator, retrieve or generating one or more alternate T-IDs, including a previous T-ID or a next T-ID, based on previously stored T-ID values in the data repository, and transmit the one or more alternate T-IDs.

In some implementations of the network entity and method described herein, the network entity is an ADM entity, the network function is an AIOTF, and the data repository is a unified data repository (UDR).

### BRIEF DESCRIPTION OF THE DRAWINGS

FIG. 1 illustrates an example of a wireless communications system in accordance with aspects of the present disclosure.

FIGS. 2A-2B illustrate example topologies for AIoT devices in accordance with aspects of the present disclosure.

FIG. 3A-3B illustrate example system architectures for communicating with AIoT devices in accordance with aspects of the present disclosure.

FIG. 4 illustrates a messaging flow for performing an IoT operation in accordance with aspects of the present disclosure.

FIGS. 5A-5C illustrate messaging flows for performing IoT operations in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by an NE in accordance with aspects of the present disclosure.

FIG. 10 illustrates a flowchart of a method performed by an NE in accordance with aspects of the present disclosure.

FIG. 11 illustrates a flowchart of a method performed by an NE in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost, complexity, and/or maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). Thus, an AIoT device may be any device that is ambient power-enabled, such as battery-less devices or devices with limited storage capabilities (e.g., devices that store a limited amount of energy using capacitors) or other restricted or limited capabilities.

A network node, such as a UE and/or NE (e.g., a base station, a radio access network (RAN) node) may operate as a reader device that communicates with AIoT devices. For example, a network node configured or operating as a reader device may transmit a carrier wave to an AIoT device to excite (e.g., activate) the AIoT device to perform backscattering transmissions or other communications, or communicate a message to the AIoT device during a procedure (e.g., AIoT selection procedure), or may receive the backscattering transmissions. The network node may communicate with various network functions, such as an AIoT function (AIOTF) that communicates directly with the network node, an application function (AF) that communicates with the network node via the AIOTF, and/or an AIoT data management (ADM) entity (e.g., an ADM) that functions to manage data and authentication for AIoT devices.

The AIoT device may perform one or more operations (e.g., transmission, reception, via backscattering) using the stored harvested energy. For example, the AIoT device may be a passive RFID tag equipped on an object or other device enabling for tracking (e.g., monitoring) of a location of the object or the other device using stored harvested energy. Example use cases or IoT operations (e.g., AIoT operations) performed by AIoT devices (e.g., one or multiple) include inventory taking or procedures (e.g., tracking and/or acknowledgement of a presence of an object) and/or command procedures (e.g., read, write, control, enable, disable, and so on), sensor data collection, asset tracking, actuator control, and so on.

In some cases, such as during an inventory procedure, the ADM entity may perform an exhaustive authentication of one or more AIoT devices during or upon initiation (e.g., at startup) of the inventory procedure. For example, to perform the authentication, the ADM entity may derive multiple expected response parameters using the respective encryption keys for AIoT devices identified via filtering information. Given that the ADM entity is stateless (e.g., does not retain information from previous interactions or procedures), the ADM entity, upon receiving the filtering information, determines (e.g., computes, recomputes, and so on) a set (e.g., a complete list) of expected response parameters associated with a group of AIoT devices for an inventory procedure. When the group of AIoT devices is large (e.g., greater than or equal to a threshold group size), the ADM entity may experience a significant processing load, which can impact scalability processing efficiencies, and other performance factors.

Further, the ADM entity may perform identity protection procedures during inventory procedures. For example, the ADM entity may perform various operations when retrieving or storing temporary identifiers (T-IDs) for AIoT devices, including fetching stored T-IDs, generating T-IDs, deriving T-IDs, and so on. However, given that the ADM entity is stateless, issues arise with storing the retrieved T-IDs, the generated T-IDs, and/or the derived T-IDs in or within AIoT device profiles. The present disclosure introduces enhancements to the functionality of the ADM entity, the AIOTF, and/or various associated data stores (e.g., a UDR). In some examples, the ADM entity may be configured to, capable of, or operable to authenticate AIoT devices identified by filtering information, permanent identifiers, T-IDs, and so on. For example, the ADM entity may perform group authentication of AIoT devices via a cache service at a UDR, where the ADM entity manages and updates (e.g., adjusts, modifies) a cache of previously authenticated AIoT devices (for group inventory procedures). The ADM entity may identify the previously authenticated AIoT devices using a session identifier (e.g., one specific to an inventory procedure) and a derivation parameter (e.g., RAND_{AIOT_n}). Thus, in various implementations, the ADM entity may experience a reduced processing load while enabling the ADM entity to maintain its stateless functionality, enabling scalable group inventory handling, and improving reliability of authentication procedures, all without modifying interactions between the AIoT devices and the associated RAN nodes, among other benefits.

Additionally, the ADM entity may perform group authentication of AIoT devices via an AIOTF, where the AIOTF is enhanced and/or extended to support the authentication of a group of AIoT devices that were previously authenticated by the ADM entity.

Additionally, the UDR may be configured to extend stored or maintained AIoT device profiles. For example, an extended AIoT device profile may store a T-ID and associated handling type (e.g., how a T-ID is generated and/or updated) using a permanent identifier for the AIoT device as a binding key for the UDR (or another database). Via the extended device profiles, the UDR may facilitate efficient T-ID lifecycle management and resynchronization, among other benefits.

Aspects of the present disclosure are described in the context of a wireless communications system.

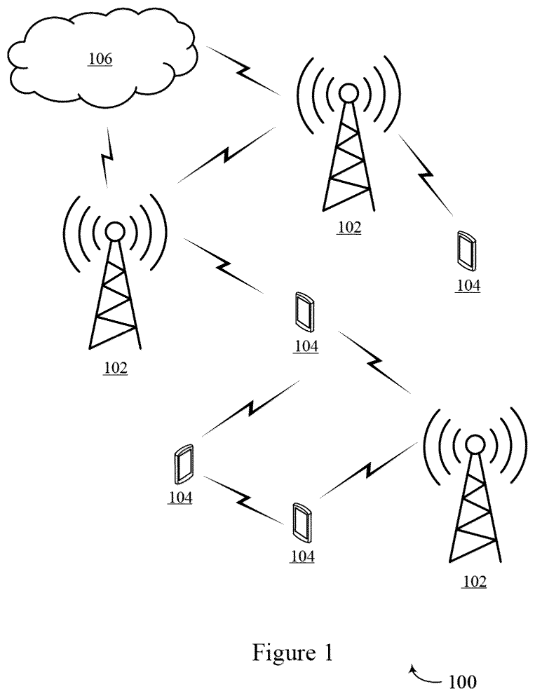

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20, and ISO18000-6C UHF RFID. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), a reader device (e.g., AIoT reader, an RFID reader), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an AIoT device, an RFID tag, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some implementations, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

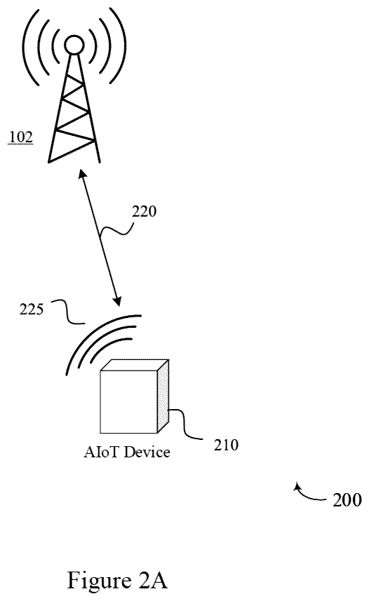

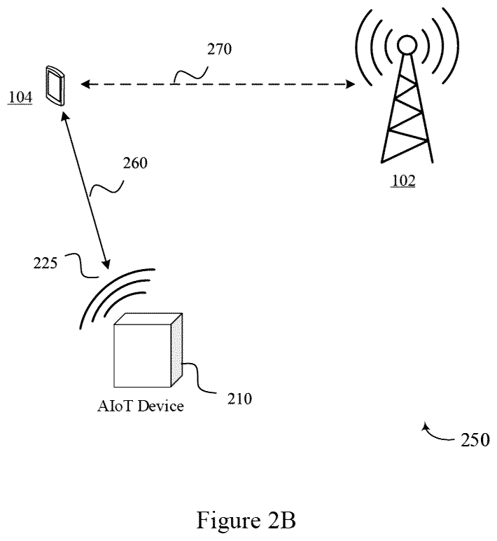

FIG. 2A illustrates an example topology 200 for AIoT devices in accordance with aspects of the present disclosure. In some examples, the topology 200 may implement or be implemented by aspects of the wireless communications system 100. For example, the topology 200 may be implemented by an NE and/or a UE, which may be an example of an NE 102 and a UE 104 as described with reference to FIG. 1. In the example of FIG. 2A, an AIoT device 210, which may be an example of a UE 104 as described with reference to FIG. 1, may directly and bidirectionally communicate with the NE 102. The NE 102 may provide communication coverage via one or more cells, for example a macro cell, a small cell, a micro cell, or other types of cells, or any combination thereof. A communication link 220 between the NE 102 and the AIoT device 210 may support communication (e.g., transfer, transmission, reception, etc.) of AIoT data (e.g., via backscattering 225) and/or other signaling (e.g., control information, data). In an example implementation, both the AIoT device 210 and the NE 102 are located indoors (with a micro cell being part of a group of cells or NEs 102).

FIG. 2B illustrates an example topology 250 for AIoT devices in accordance with aspects of the present disclosure. In some examples, the topology 250 may implement or be implemented by aspects of the wireless communications system 100. For example, the topology 250 may be implemented by an NE and/or a UE, which may be an example of an NE 102 and a UE 104 as described with reference to FIG. 1. In the example of FIG. 2B, a UE 104, or another network node, may act (e.g., function, operate) as an intermediate node between an NE 102 and an AIoT device 210. For example, the UE 104 may function as an emitter and/or reader, where the UE 104 sends (e.g., outputs, transmits) carrier waves to the AIoT device 210, which excite (e.g., activate) the AIoT device 210, enabling or causing the AIoT device 210 to perform the backscattering transmissions 225, which may be received and read (e.g., demodulated, decoded) by the UE 104.

The AIoT device 210 may directly and bidirectionally communicate with the UE 104 (e.g., which may relay data to the NE 102, serving a macro cell). A communication link 260 between the UE 104 and the AIoT device 210 and/or a link 270 between the UE 104 and the NE 102 may support communication (e.g., transfer, transmission, reception, etc.) of AIoT data (e.g., via backscattering 225) and/or other signaling (e.g., control information, data). In an example implementation, the AIoT device 210 and the UE 104 are both located indoors, and the NE 102 is located outdoors (with the macro cell being part of a group of cells or NEs 102).

The AIoT device 210 may communicate with the intermediate node (e.g., the UE 104 or another network node) and/or the network (e.g., via the NE 102) using a reduced set of components (e.g., protocol layers, circuitry, hardware). For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

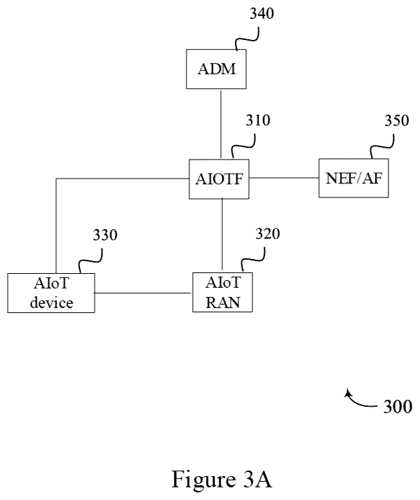

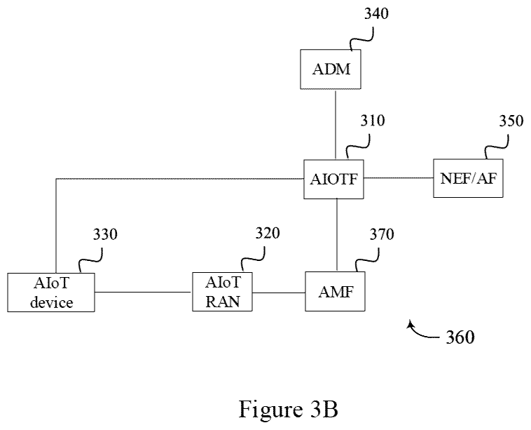

FIG. 3A-3B illustrate example system architectures for communicating with AIoT devices in accordance with aspects of the present disclosure. FIG. 3A depicts a direct path (or direct connectivity) architecture 300, wherein an AIOTF 310 communicates directly with an AIoT RAN 320 via a reference point (e.g., AIOT2) when performing AIoT operations. FIG. 3B depicts an indirect path (or indirect connectivity) architecture 360, where the AIOTF 310 communicates indirectly with the AIoT RAN 320 via an AMF 370 (e.g., via an AIOT3 reference point between the AIOTF 310 and the AMF 370.

In some cases, the AIOTF 310 is a network function in the CN 106 that supports AIoT services (e.g., inventory/command procedures). The AIOTF 310 may select AIoT RAN nodes and may support one or more BS readers (where a BS reader serves a defined service area within the AIoT RAN 320). The AIOTF 310 receives AIoT service requests from an AF 350 (e.g., or network exposure function (NEF)) and triggers the AIoT RAN 320 to perform AIoT service operations with or towards AIoT devices (e.g., the AIoT device 330). The AF 350 may be an AIoT service consumer or operator.

The AIoT RAN 320 may be the NE 102, the UE 104, or other device that is associated with a reader device, as described herein. The reader device may be coupled to the AIoT RAN 320 via an RRC protocol and configured send and receive AIoT messages to/from an AIoT device 330 via the RRC protocol to the AIoT RAN 320. The AIoT RAN 320 may communicate to/from the AIOTF 310.

In some cases, the AIoT device 330 and the AIOTF 310 may exchange messages via a reference point (e.g., AIOT1). The AIOT1 reference point may be used to transfer AIoT data (e.g., data to be written to the AIoT device 330 or read from the AIoT device 330) between the AIoT device 330 and the AIOTF 310.

An ADM 340 (e.g., an ADM entity) is configured to manage AIoT device profile data. The ADM 340 may be similar to or associated with a unified data management (UDM) or unified data repository (UDR) function, where data profiles and subscription data for UEs 104 (e.g., AIoT devices) is stored. The ADM 340 manages and stores profiles of AIoT devices (e.g., the AIoT device 330), including AIoT device permanent IDs, corresponding credentials, last known location information, and so on. The AIOTF 310 may exchange messages with the ADM 340 via an AIOT6 reference point.

In some cases, a globally unique AIoT device permanent identifier is allocated to each AIoT device. The AIoT device permanent identifier may be assigned by an operator or a third party and is used to identify an AIoT device (e.g., the AIoT device 330) and locate an entity where device information is stored.

As described herein, the ADM 340 may function to store retrieved, generated, and/or derived T-IDs in or within AIoT device profiles. To ensure the ADM 340 operates efficiently while maintaining its stateless functionality, the UDR may store extended AIoT device profiles. For example, an extended AIoT device profile may store a T-ID and associated handling type (e.g., how a T-ID is generated) using permanent identifiers for the AIoT devices as binding keys for the UDR. Table depicts an example extended AIoT device profile.

TABLE 1

| Field | Description |
|---|---|
| AIoT Device Permanent ID | Uniquely identifies the AIoT Device. |
| Last known AIoTF | Indicate the last known AIoTF that |
| information | serves the AIoT device, or unknown |
| T-ID | Temporary ID of the AIoT device as |
| | specified in TS 33.369 |
| T-ID handling type | The handling type of the T-ID as |
| | specified in TS 33.369 |

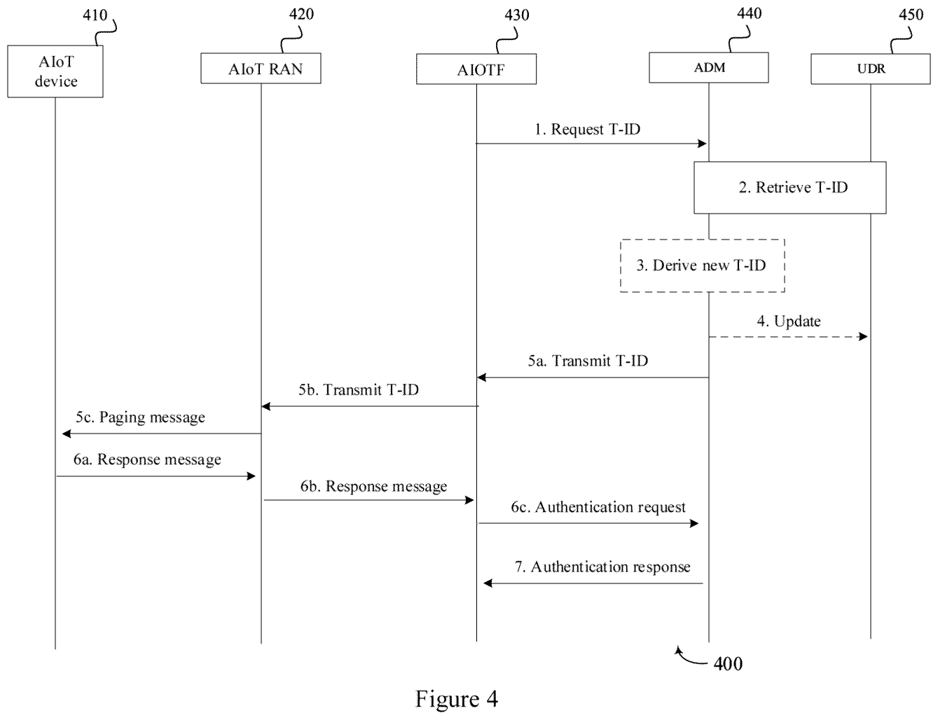

The operation of the ADM 340, along with extended AIoT device profiles, during an inventory procedure may be implemented as follows. FIG. 4 illustrates a messaging flow 400 for performing an IoT operation in accordance with aspects of the present disclosure.

The messaging flow 400 may include an AIoT device 410, an AIoT RAN 420 (e.g., a reader device), an AIOTF 430, an ADM 440 (e.g., an ADM entity), and a UDR 450, which may be examples of AIoT devices, AIT RANS, AIOTFs, ADMs, and UDRs as described herein. In the following description of the messaging flow 400, the operations between the AIoT device 410, the AIoT RAN 420, the AIOTF 430, the ADM 440, and the UDR 450 may be performed in different orders or at different times. Some operations may also be omitted, or other operations may be added. Although the AIoT device 410, the AIoT RAN 420, the AIOTF 430, the ADM 440, and the UDR 450 are shown performing the operations of the messaging flow 400, some aspects of some operations may also be performed by other entities of the messaging flow 400 or by entities that are not shown in the messaging flow 400, or any combination thereof.

At step 1, the AIOTF 430 a requests T-ID from the ADM 440. For example, for a given AIoT device permanent identifier, the AIOTF 430 requests a T-ID, including a T-ID handling type (e.g., stored no update, update with command, update with no command, concealed from stored, concealed from permanent, unconcealed/unstored for no privacy usage, and so on).

At step 2, the ADM 440 retrieves a T-ID record from the UDR 450. For example, the ADM 440 may retrieve the T-ID using a permanent identifier as a data key. In some cases, such as when no T-ID exists and the T-ID handling type is stored, the ADM 440 may prepare for provisioning a new T-ID.

At step 3, the ADM 440 derives a T-ID. For example, in cases where the rotation of T-IDs is required or requested, the ADM 440 may derive a new T-ID using a T-IDₙ₋₁.

At step 4, when a new T-ID is derived, created, or rotated, the ADM 440 updates the UDR 450 with the new T-ID and T-IDₙ₋₁, if available. For example, the ADM 440 may transmit the permanent identifier, the new T-ID, and an associated handling type for the T-ID to the UDR 450.

At step 5a, the ADM 440 transmits the T-ID and the handling type to the AIOTF 430. At step 5b, the AIOTF 430 transmits the received T-ID to the AIoT RAN 420. At step 5c, the AIoT RAN 420 transmits a paging message to the AIoT device 410. For example, the paging message may include the T-ID, the handling type, and a derivation parameter (e.g., RAND_{AIOT_n}).

At step 6a, the AIoT device 410 transmits a paging response message to the AIOT RAN 420. For example, the AIoT device 410 matches the T-ID to stored identity information and transmits a D2R message that contains a response parameter (e.g., RES_{AIOT}) and a derivation parameter (RAND_{AIOT_d}). At step 6b, the AIoT RAN 420 forwards the response message to the AIOTF 430. At step 6c, the AIOTF 430 forwards the response message to the ADM 440 for authentication by the ADM 440.

In some cases, the AIoT device 410 may not respond to the paging request message, and the AIOTF 430 may request, from the ADM 440, a different T-ID (e.g., a T-ID_n−1 and/or T-ID_n+1) using a resynchronization indicator. The ADM 440 may retrieve or generate these T-IDs based on previous T-ID values stored in UDR 450. The AIOTF 430 may send the new T-ID (e.g., T-ID_n−1 or T-ID_n+1) to the AIoT RAN 420 for paging the AIoT device 410.

At step 7, the ADM 440 transmits an authentication response to the AIOTF 430. For example, the ADM 440 authenticates the AIoT device 410 using the permanent identifier and by computing an expected response parameter (e.g., XRES_{AIOT}) and returns the result to the AIOTF 430. The ADM 440 may also derive keys in response to receiving command messages.

In some cases, the ADM 440 may perform resynchronization handling during authentication, where the ADM 440 may retry the authentication (when out-of-sync) with a previous T-ID (or a different handling type) and update the UDR 450 upon any successful recovery.

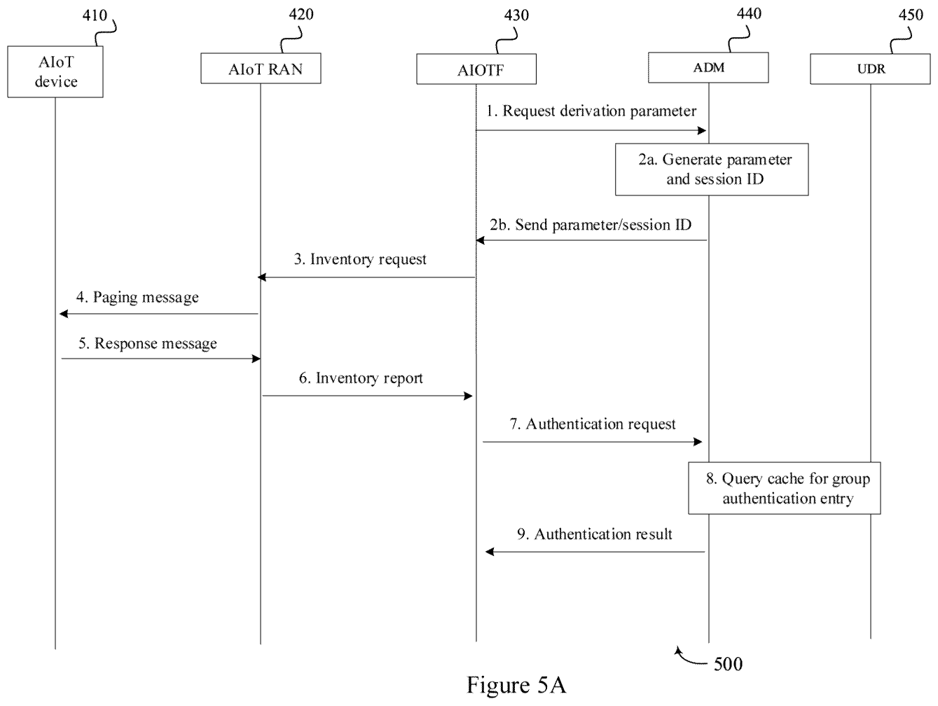

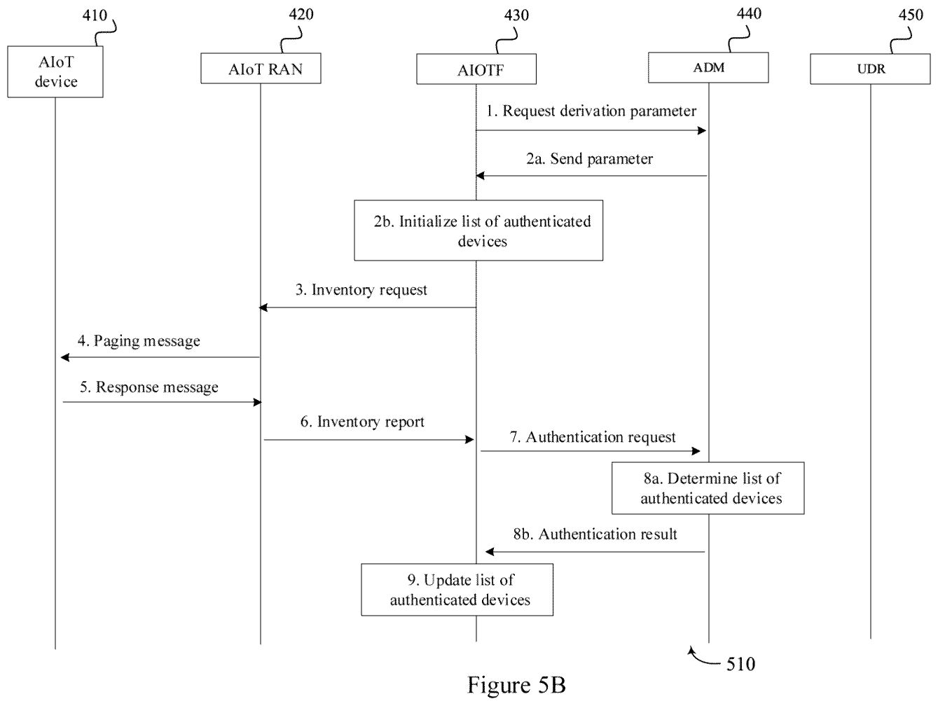

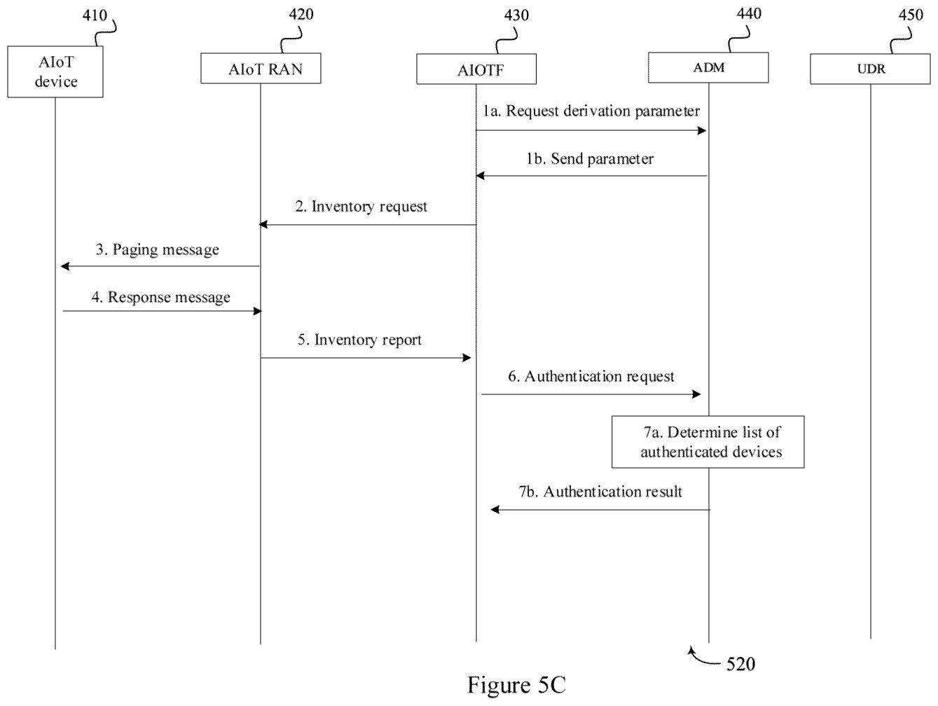

As described herein, in some examples, the ADM 440 has been configured to perform the group authentication of AIOT devices. For example, the ADM 440 may utilize a group authentication cache or data store in the UDR 450. FIG. 5A illustrates a messaging flow 500 for performing IoT operations in accordance with aspects of the present disclosure.

The messaging flow 500 may include an AIoT device 410, an AIoT RAN 420 (e.g., a reader device), an AIOTF 430, an ADM 440, and a UDR 450, which may be examples of AIoT devices, AIoT RANs, AIOTFs, ADMs, and UDRs as described herein. In the following description of the messaging flow 500, the operations between the AIoT device 410, the AIoT RAN 420, the AIOTF 430, the ADM 440, and the UDR 450 may be performed in different orders or at different times. Some operations may also be omitted, or other operations may be added. Although the AIoT device 410, the AIoT RAN 420, the AIOTF 430, the ADM 440, and the UDR 450 are shown performing the operations of the messaging flow 500, some aspects of some operations may also be performed by other entities of the messaging flow 500 or by entities that are not shown in the messaging flow 500, or any combination thereof.

In some examples, the messaging flow 500 supports or represents an AIoT inventory procedure, such as an authentication procedure associated with an inventory procedure performed by the AIOT device 410.

At step 1, the AIOTF 430 sends a derivation parameter request to the ADM 440. For example, the AIOTF 430 sends a request to the ADM 440 to generate the RAND_{AIOT_n} for a group inventory request (e.g., identified by filtering information).

At step 2a, the ADM 440 generates the derivation parameter and creates a unique session ID for the group inventory procedure. For example, the ADM 440 generates the RAND_{AIOT_n} and the session ID, for correlating responses to requests from AIoT devices that reply based on the filtering information. At step 2b, The ADM 440 sends the derivation parameter and the session ID to the AIOTF 430. For example, the ADM 440 sends the RAND_{AIOT_n} and a session ID, which may be based on the filtering information, to the AIOTF 430.

At step 3, the AIOTF 430 sends an inventory request to the AIoT RAN 420. For example, the inventory request includes the RAND_{AIOT_n} and the filtering information.

At step 4, the AIoT RAN 420 sends a paging message to the AIoT device 410 (e.g., part of a group of AIOT devices). For example, the paging message includes the RAND_{AIOT_n} and the filtering information.

At step 5, the AIoT device 410 (or a group of AIoT devices) sends a response message to the AIoT RAN 420. For example, the AIoT device 410 evaluates the filtering information and, when the information matches a stored identity, generates a RAND_{AIOT_d}, and computes the RES_{AIOT} using a root key (e.g., K_{AIoT_root}). The AIoT device 410 sends a D2R message containing the RES_{AIOT} and the RAND_{AIOT_d} to the AIOT RAN 420.

At step 6, the AIoT RAN 420 sends an inventory report to the AIOTF 430. For example, the AIoT RAN 420 sends an inventory report, which includes the RES_{AIOT} and the RAND_{AIOT_d}, to the AIOTF 430.

At step 7, the AIOTF 430 sends an authentication request to the ADM 440. For example, the AIOTF 430 invokes the ADM 440 for authentication by sending the session ID (e.g., from step 2), the filtering information, the RAND_{AIOT_n}, the RAND_{AIOT_d}, and the RES_{AIOT}.

At step 8, the ADM 440 queries a cache at the UDR 450 for a group authentication entry. For example, the ADM 440 checks the UDR 450 for an existing group authentication cache entry using the session ID and the RAND_{AIOT_n}.

In some examples, such as when no cache exists (e.g., upon a first inventory report for a session or operation, and/or may accumulate responses from AIoT devices at a common reader device), the ADM 440 may perform the following procedure.

The ADM 440 derives candidate devices (e.g., a list of AIoT device permanent identifiers used for authentication) from the received filter information and creates a group authentication cache entry in the UDR 450 that contains the session ID, the RAND_{AIOT_n}, an AuthDevSet, and a ttlSeconds parameter. In some cases, the session ID defines a unique session ID for a group inventory assigned by the ADM 440, where the AIOTF 430 includes the session ID some or all responses from the AIoT device 410 to the ADM 440 that map to respective correlation IDs from the AIoT RAN 420.

In some cases, the AuthDevSet defines a list of already authenticated AIoT device permanent identifiers in the group inventory request, and the ttlSeconds parameter defines a number of seconds (e.g., a time period or interval) to store the group authentication cache entry in the UDR 450. In some cases, the ttlSeconds parameter may be based on: an expected time, such as a time period long enough to receive all responses from AIoT device group members, a number of AIoT devices in a group inventory procedure, characteristics of the inventory procedure, or various combinations.

In some examples, such as when the cache exists, the ADM 440 retrieves the cached AuthDevSet from the UDR 450 and derives the candidate AIoT devices from the received filter information. The ADM 440 may generate a list of previously authenticated AIoT devices, where the candidate AIoT devices exclude previously authenticated AIoT devices. In some cases, the ADM 440 may perform some or all aspects of step 8 as part of step 2.

At step 9, the ADM 440 sends an authentication result to the AIOTF 430. For example, the ADM 440 may compute an expected response parameter (e.g., XRES_{AIOT}) value for each of the candidate devices, based on their AIoT device permanent identifiers, the K_{AIoT_root}, the RAND_{AIOT_n}, and the RAND_{AIOT_d}. The ADM 440 compares the received response parameter (e.g., RES_{AIOT}) with the computed XRES_{AIOT} values to identify matching AIoT device permanent identifiers. When a match is found, the ADM 440 adds the matching AIoT device permanent identifier to the list of already authenticated devices in the UDR 450. The ADM 440 returns the authentication result (e.g., a list of authenticated AIoT device permanent identifiers along with their corresponding XRES_{AIOT} values) to the AIOTF 430. Upon a successful result and in response to a command procedure, the ADM 440 derives K_{AIOTF} and related keys. The AIOTF 430 may determine that a returned AIoT device permanent identifier as being authenticated.

Thus, the ADM 440, by utilizing the group authentication cache in the UDR 450, may identify and exclude previously authenticated AIoT devices from response parameter computations, and thus reduce the processing of candidate devices and improve its efficiency, among other benefits.

In some cases, such as when the AIOTF 430 determines that the inventory procedure for all associated AIoT devices (e.g., associated with the filtering information) is complete, the AIOTF 430 may indicate to the ADM 440 that the inventory procedure is complete. In response, the ADM 440 may request the UDR 450 to delete the group authentication cache using the session ID and the RAND_{AIOT_n}. In some cases, the ADM 440 may not cause the UDR 450 to delete the group authentication cache (e.g., the cache may be automatically removed upon expiration of a time period based on the on ttlSeconds parameter).

In some cases, the AIOTF 430 may use the filtering information and/or the RAND_{AIOT_n} instead of a unique session ID when invoking the ADM 440 for authentication. The ADM 440 may use the filtering information and/or RAND_{AIOT_n} to create or access the group authentication cache entry. The AIOTF 430 may locally store the RAND_{AIOT_n} (at step 2). In some cases, such as when more than one AIOTF is involved in an inventory or command procedure, a unique session ID may be generated when the AIOTFs are selected by a network exposure function (NEF) or an AF.

As described herein, in some examples, the ADM 440 may utilize a group authentication cache or data store in the AIOTF 430. FIG. 5B illustrates a messaging flow 510 for performing IoT operations in accordance with aspects of the present disclosure.

The messaging flow 510 may include an AIoT device 410, an AIoT RAN 420 (e.g., a reader device), an AIOTF 430, an ADM 440, and a UDR 450, which may be examples of AIoT devices, AIoT RANs, AIOTFs, ADMs, and UDRs as described herein. In the following description of the messaging flow 510, the operations between the AIoT device 410, the AIoT RAN 420, the AIOTF 430, the ADM 440, and the UDR 450 may be performed in different orders or at different times. Some operations may also be omitted, or other operations may be added. Although the AIoT device 410, the AIoT RAN 420, the AIOTF 430, the ADM 440, and the UDR 450 are shown performing the operations of the messaging flow 510, some aspects of some operations may also be performed by other entities of the messaging flow 510 or by entities that are not shown in the messaging flow 510, or any combination thereof.

In some examples, the messaging flow 510 supports or represents an AIoT inventory procedure, such as an authentication procedure associated with an inventory procedure performed by the AIoT device 410.

At step 1, the AIOTF 430 sends a derivation parameter request to the ADM 440. For example, the AIOTF 430 sends a request to the ADM 440 to generate the RAND_{AIOT_n} for a group inventory request (e.g., identified by filtering information).

At step 2a, the ADM 440 sends a derivation parameter to the AIOTF 430. For example, the ADM 440 generates the RAND_{AIOT_n} and sends the parameter to the AIOTF 430. At step 2b, the AIOTF 430 initializes a list of authenticated devices. For example, the AIOTF 430 initializes a locally stored list of already authenticated AIoT devices (e.g., a list of AIoT device permanent identifiers), where each entry represents an AIoT device that has previously completed authentication.

At step 3, the AIOTF 430 sends an inventory request to the AIoT RAN 420. For example, the inventory request includes the RAND_{AIOT_n} and filtering information.

At step 4, the AIoT RAN 420 sends a paging message to the AIoT device 410 (e.g., a group of AIoT devices). For example, the paging message includes the RAND_{AIOT_n} and the filtering information.

At step 5, the AIoT device 410 (or a group of AIoT devices) sends a response message to the AIoT RAN 420. For example, the AIoT device 410 evaluates the filtering information and, when the information matches a stored identity, generates a RAND_{AIOT_d}, and computes the RES_{AIOT} using a root key (e.g., K_{AIoT_root}). The AIoT device 410 sends a D2R message containing the RES_{AIOT} and the RAND_{AIOT_d} to the AIoT RAN 420.

At step 6, the AIoT RAN 420 sends an inventory report to the AIOTF 430. For example, the AIoT RAN 420 sends an inventory report, which includes the RES_{AIOT} and the RAND_{AIOT_d}, to the AIOTF 430.

At step 7, the AIOTF 430 sends an authentication request to the ADM 440. For example, the AIOTF 430 invokes the ADM 440 to provide authentication and includes information for the candidate devices (e.g., filter information or AIoT device permanent identifers), the RAND_{AIOT_n}, and the RAND_{AIOT_d}. In some cases, the AIOTF 430 adjusts the candidate devices to exclude the devices already stored in the list of authenticated devices.

At step 8a, the ADM 440 determines a list of authenticated devices. For example, the ADM 440 computes the XRES_{AIOT} value for the candidate devices using their AIoT device permanent identifiers, the K_{AIoT_root}, the RAND_{AIOT_n}, and the RAND_{AIOT_d}. At step 8b, the ADM 440 sends an authentication result to the AIOTF 430. For example, the ADM 440 returns a list of AIoT device permanent identifiers along with their corresponding XRES_{AIOT} values to the AIOTF 430.

At step 9, the AIOTF 430 updates a list of authenticated AIoT devices. For example, the AIOTF 430 compares the received RES_{AIOT} with the list of AIOT device permanent identifiers and corresponding XRES_{AIoT} values to determine matching AIoT device permanent identifiers. When verification is successful, the AIOTF 430 adds the matching AIoT device permanent identifiers to the list of already authenticated devices. Upon a successful result and in response to a command procedure, the ADM 440 derives K_{AIOTF} and related keys. Further, upon receipt of a last inventory report, the AIOTF 430 may perform a local cleanup of any session parameters.

Thus, the AIOTF 430 may utilize a locally stored list of already authenticated AIoT devices to assist ADM in reducing its computing load (e.g., in stateless ADM implementations) when authenticating devices. Further, the ADM 440 may exclude previously authenticated AIoT devices from XRES_{AIOT} value computations, reducing the number of candidate devices to process, which can minimize the performance of redundant calculations and improves its overall efficiency, among other benefits.

As described herein, in some examples, the ADM 440 may aggregate authentication requests. FIG. 5C illustrates a messaging flow 520 for performing IoT operations in accordance with aspects of the present disclosure.

The messaging flow 520 may include an AIoT device 410, an AIoT RAN 420 (e.g., a reader device), an AIOTF 430, an ADM 440, and a UDR 450, which may be examples of AIoT devices, AIoT RANs, AIOTFs, ADMs, and UDRs as described herein. In the following description of the messaging flow 520, the operations between the AIoT device 410, the AIoT RAN 420, the AIOTF 430, the ADM 440, and the UDR 450 may be performed in different orders or at different times. Some operations may also be omitted, or other operations may be added. Although the AIoT device 410, the AIoT RAN 420, the AIOTF 430, the ADM 440, and the UDR 450 are shown performing the operations of the messaging flow 520, some aspects of some operations may also be performed by other entities of the messaging flow 520 or by entities that are not shown in the messaging flow 520, or any combination thereof.

In some examples, the messaging flow 510 supports or represents an AIT inventory procedure, such as an authentication procedure associated with an inventory procedure performed by the AIoT device 410.

At step 1a, the AIOTF 430 sends a derivation parameter request to the ADM 440. For example, the AIOTF 430 sends a request to the ADM 440 to generate the RAND_{AIOT_n} for a group inventory request (e.g., identified by filtering information). At step 1b, the ADM 440 sends a derivation parameter to the AIOTF 430.

At step 2, the AIOTF 430 sends an inventory request to the AIOT RAN 420. For example, the inventory request includes the RAND_{AIOT_n} and filtering information.

At step 3, the AIoT RAN 420 sends a paging message to the AIoT device 410 (e.g., a group of AIOT devices). For example, the paging message includes the RAND_{AIOT_n} and the filtering information.

At step 4, the AIoT device 410 (or a group of AIoT devices) sends a response message to the AIoT RAN 420. For example, the AIoT device 410 evaluates the filtering information and, when the information matches a stored identity, generates a RAND_{AIOT_d}, and computes the RES_{AIOT} using a root key (e.g., K_{AIoT_root}). The AIoT device 410 sends a D2R message containing the RES_{AIOT} and the RAND_{AIOT_d} to the AIoT RAN 420.

At step 5, the AIoT RAN 420 sends an inventory report to the AIOTF 430. For example, the AIoT RAN 420 sends an inventory report, which includes the RES_{AIOT} and the RAND_{AIOT_d}, to the AIOTF 430.

At step 6, the AIOTF 430 sends an authentication request to the ADM 440. For example, the AIOTF 430 requests the ADM 440 to compute the XRES_{AIOT} value for each AIoT device in the group using filter information and/or AIoT device permanent identifiers, the K_{AIoT_root}, the RAND_{AIOT_n}, the RAND_{AIOT_d}, and the RES_{AIOT} (or multiple parameters associated with multiple devices).

At step 7a, the ADM 440 determines a list of authenticated AIoT devices. For example, the ADM 440 computes, for every RAND_{AIOT_d} value, the XRES_{AIOT} values of the group of AIoT devices, and determines the matching AIoT device permanent identifiers by comparing the XRES_{AIOT} values with the provided RES_{AIOT} values. Thus, once an AIoT device permanent identifier is matched, the device is excluded from any subsequent XRES_{AIOT} computation. At step 7b, the ADM 440 sends an authentication result to the AIOTF 430. For example, the ADM 440 provides the list of authenticated AIoT device permanent identifiers along with their corresponding XRES_{AIOT} values to the AIOTF 430.

Upon a successful result and in response to a command procedure, the ADM 440 derives K_{AIOTF} and related keys. The AIOTF 430 may determine that a returned AIoT device permanent identifier as being authenticated.

Thus, the ADM 440 may authenticate multiple AIoT devices of a group in a single request, which may reduce the computing load in stateless ADM implementations. For example, each AIoT device provides its own RES_{AIOT} value, and the ADM 440 computes the expected response (XRES_{AIOT}) values for all candidate devices in a batch. Once an AIoT device is successfully authenticated, the device is excluded from further computations, reducing the number of devices to process in subsequent steps or authentication procedures. The ADM 440, therefore may minimize redundant calculations and improves its overall efficiency, among other benefits.

In some cases, at step 6, when the AIOTF 430 sends an authentication request to the ADM 440, the ADM 440 may, based on its computation capabilities and the received filtering information, determine that the group of devices is too large to compute the expected response values (XRES_{AIOT}) in a reasonable amount of time. In this case, the ADM 440 may return an error in step 7b indicating that the group size exceeds its processing capacity.

In some examples, a new ADM service for the AIoT device 410 authentication is specified as depicted in table 2 below.

TABLE 2
Nadm_Authentication_Get service operation

| | |
|---|---|
| Service | Nadm_Authentication_Get |
| operation | |
| name | |
| Description | Requester NF gets authentication data, the K_{AIOTF} |
| | and derived keys from ADM. |
| Input, | AIoT filtering information or AIoT Device Permanent |
| Required | ID(s) or T-ID(s), RAND_{AIOT}_{_{—}}ₙ, RAND_{AIOT}_{_{—}}_{d}(s), |
| | RES_{AIOT}(s). |
| Input, | Indication for deriving session keys, Session ID, |
| Optional: | list of already authenticated devices. |
| Output, | One or more authenticated AIoT Device Permanent |
| Required | ID(s) with corresponding XRES_{AIOT} value(s). |
| Output, | K_{AIOTF,} K_{Command}_{_{—}}_{enc}, K_{Command}_{_{—}}ᵢₙₜ values for |
| Optional | each of the authenticated AIoT Device Permanent IDs, |
| | error indication |

NOTE 1:
The parameter list of already authenticated devices provides the AIoT Device Permanent IDs that have successfully completed authentication. The ADM excludes these devices from the list of candidates when computing XRES_{AIOT} values, thereby reducing the number of devices to process. This helps lower the computational load on the ADM and improves overall efficiency.
NOTE 2:
The parameter Session ID is used by the ADM to reference a Group Authorization cache stored in UDR. Group Authorization cache contains the AIoT Device Permanent IDs that have successfully completed authentication. The ADM excludes these devices from the list of candidates when computing XRES_{AIOT} values, thereby reducing the number of devices to process. This helps lower the computational load on the ADM and improves overall efficiency.
NOTE 3:
The parameter error indication is used by the ADM to indicate if the group of devices derived from the filter information is too large to compute the expected response values (XRES_{AIOT}) in a reasonable amount of time.

In some examples, a new ADM service for generating T-IDs is specified as depicted in table 3 below.

TABLE 3
Nadm_TID_Get service operation

| | |
|---|---|
| Service operation | Nadm_TID_Get |
| name | |
| Description | Requester NF gets the Temporary ID (T-ID) for |
| | a given AIoT device from ADM. |
| Input, Required | AIoT Device Permanent ID |
| Input, Optional: | T-ID handling indication (e.g., stored no update, |
| | update with command, update with no command, |
| | concealed from stored, concealed from permanent, |
| | none), resync indicator. |
| Output, Required | T-ID, T-ID type |
| Output, Optional | T-ID_n − 1, T-ID_n + 1 |

NOTE 1:
ADM retrieves T-ID record from UDR using AIoT device permanent ID as datakey. If none exists and T-ID handling type is stored, ADM prepares for first provisioning. ADM updates UDR when a stored T-ID is created or rotated, providing AIoT device permanent ID, T-ID, handling type.
NOTE 2:
When the resync indicator is included in the request, the ADM in addition provides T-ID_n − 1 and/or T-ID_n + 1 in the response.

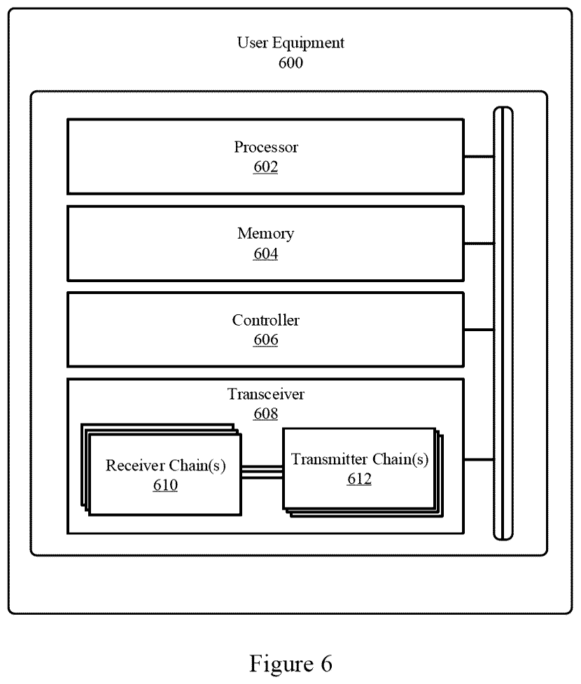

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

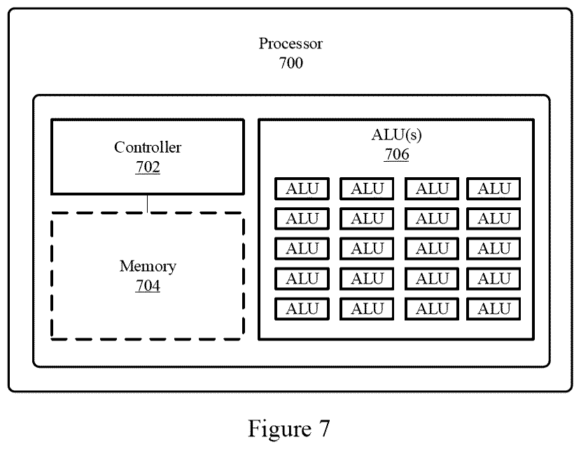

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein.

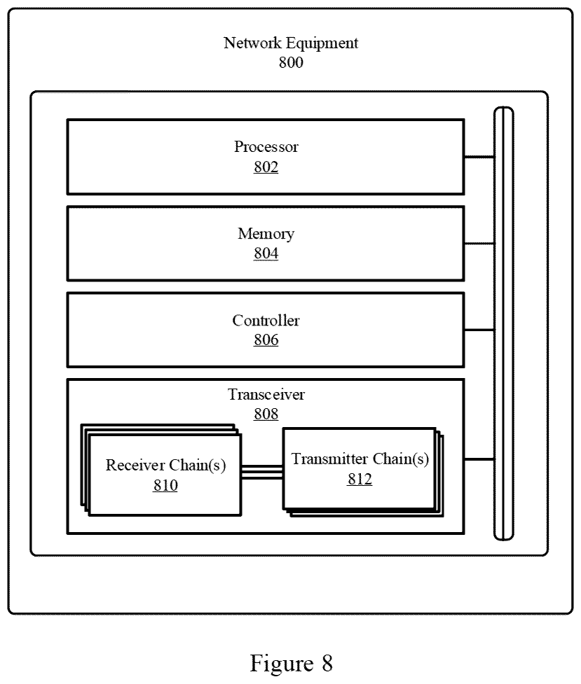

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 (e.g., as an AIOTF) may be configured to support a means for receiving a request to perform an inventory procedure using a group of AIoT devices, identifying, via a cache locally stored at the network function, a list of previously authenticated AIoT devices from the group of AIoT devices, and transmitting, to an ADM entity, a request to authenticate the group of AIoT devices excluding the list of previously authenticated AIoT devices.

As another example, the NE 800 (e.g., as an ADM or ADM entity) may be configured to support a means for receiving a request for authentication of a group of AIoT devices during an AIoT operation, wherein the request includes a session identifier associated with the AIoT operation, filtering information, and a derivation parameter, identifying one or more previously authenticated AIoT devices from the group of AIoT devices based at least in part on the session identifier and the derivation parameter, and authenticating one or more AIoT devices from the group of AIoT devices other than the identified one or more previously authenticated AIoT devices.

As another example, the NE 800 (e.g., as an ADM or ADM entity) may be configured to support a means for receiving a request from a network function for a T-ID associated with a permanent identifier of an AIoT device, wherein the request includes a T-ID handling type, retrieving a T-ID record from a data repository using the permanent identifier as a key, determining whether a T-ID exists for the AIoT device, in response to determining that no T-ID exists and the handling type indicates a stored T-ID, provisioning a new T-ID, and transmitting the T-ID and the handling type to the network function for paging the AIoT device during an AIoT operation.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

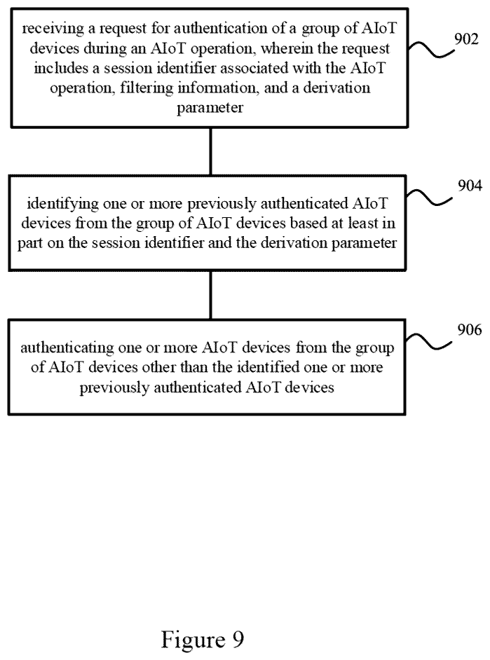

FIG. 9 illustrates a flowchart of a method in accordance with aspects of the present disclosure. The operations of the method may be implemented by an NE (e.g., as an ADM) as described herein. In some implementations, the NE may execute a set of instructions to control the function elements of the NE to perform the described functions.

At 902, the method may include receiving a request for authentication of a group of AIoT devices during an AIoT operation, wherein the request includes a session identifier associated with the AIoT operation, filtering information, and a derivation parameter. The operations of 902 may be performed in accordance with examples as described herein. In some implementations, aspects of the operations of 902 may be performed by an NE as described with reference to FIG. 8.

At 904, the method may include identifying one or more previously authenticated AIoT devices from the group of AIoT devices based at least in part on the session identifier and the derivation parameter. The operations of 904 may be performed in accordance with examples as described herein. In some implementations, aspects of the operations of 904 may be performed by an NE as described with reference to FIG. 8.

At 906, the method may include authenticating one or more AIoT devices from the group of AIoT devices other than the identified one or more previously authenticated AIoT devices. The operations of 906 may be performed in accordance with examples as described herein. In some implementations, aspects of the operations of 906 may be performed by an NE as described with reference to FIG. 8.

It should be noted that the method described herein describes a possible implementation, and that the operations and the steps may be rearranged or otherwise modified and that other implementations are possible.

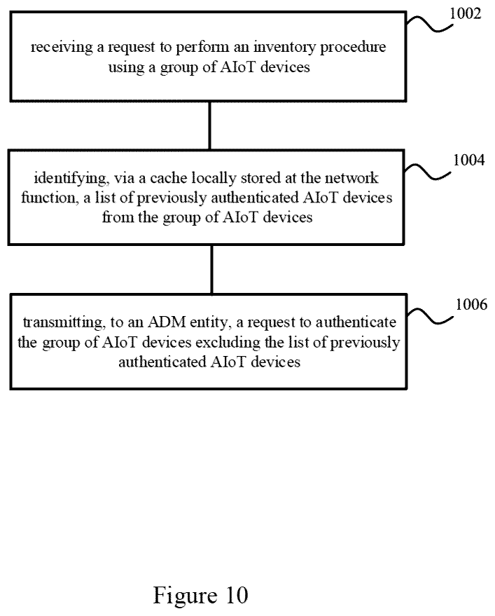

FIG. 10 illustrates a flowchart of a method in accordance with aspects of the present disclosure. The operations of the method may be implemented by an NE (e.g., as an AIOTF or other network function) as described herein. In some implementations, the NE may execute a set of instructions to control the function elements of the reader device to perform the described functions.

At 1002, the method may include receiving a request to perform an inventory procedure using a group of AIoT devices. The operations of 1002 may be performed in accordance with examples as described herein. In some implementations, aspects of the operations of 1002 may be performed by an NE as described with reference to FIG. 8.

At 1004, the method may include identifying, via a cache locally stored at the network function, a list of previously authenticated AIoT devices from the group of AIoT devices. The operations of 1004 may be performed in accordance with examples as described herein. In some implementations, aspects of the operations of 1004 may be performed by an NE as described with reference to FIG. 8.

At 1006, the method may include transmitting, to an ADM entity, a request to authenticate the group of AIoT devices excluding the list of previously authenticated AIoT devices. The operations of 1006 may be performed in accordance with examples as described herein. In some implementations, aspects of the operations of 1006 may be performed by an NE as described with reference to FIG. 8.

It should be noted that the method described herein describes a possible implementation, and that the operations and the steps may be rearranged or otherwise modified and that other implementations are possible.

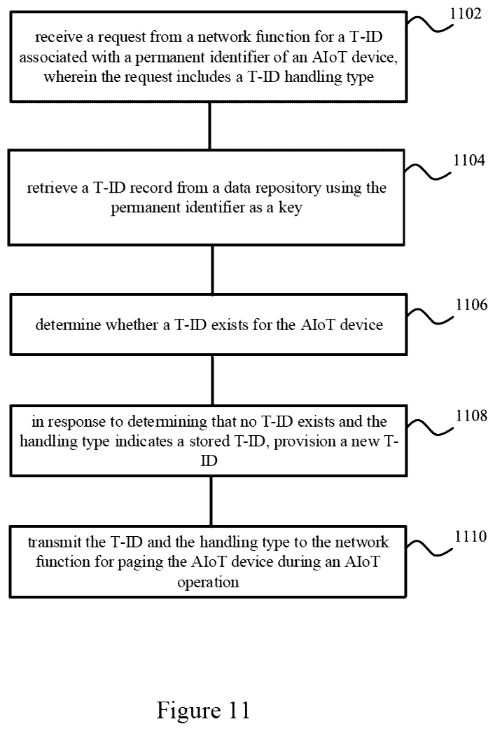

FIG. 11 illustrates a flowchart of a method in accordance with aspects of the present disclosure. The operations of the method may be implemented by an NE (e.g., as an ADM) as described herein. In some implementations, the NE may execute a set of instructions to control the function elements of the NE to perform the described functions.

At 1102, the method may include receiving a request from a network function for a T-ID associated with a permanent identifier of an AIoT device, wherein the request includes a T-ID handling type. The operations of 1102 may be performed in accordance with examples as described herein. In some implementations, aspects of the operations of 1102 may be performed by an NE as described with reference to FIG. 8.

At 1104, the method may include retrieving a T-ID record from a data repository using the permanent identifier as a key. The operations of 1104 may be performed in accordance with examples as described herein. In some implementations, aspects of the operations of 1104 may be performed by an NE as described with reference to FIG. 8.

At 1106, the method may include determining whether a T-ID exists for the AIoT device. The operations of 1106 may be performed in accordance with examples as described herein. In some implementations, aspects of the operations of 1106 may be performed by an NE as described with reference to FIG. 8. The operations of 1106 may be performed in accordance with examples as described herein. In some implementations, aspects of the operations of 1106 may be performed by an NE as described with reference to FIG. 8.

At 1108, the method may include, in response to determining that no T-ID exists and the handling type indicates a stored T-ID, provisioning a new T-ID. The operations of 1108 may be performed in accordance with examples as described herein. In some implementations, aspects of the operations of 1108 may be performed by an NE as described with reference to FIG. 8.

At 1110, the method may include transmitting the T-ID and the handling type to the network function for paging the AIoT device during an AIoT operation. The operations of 1110 may be performed in accordance with examples as described herein. In some implementations, aspects of the operations of 1110 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
one or more memories; and
one or more processors coupled with the one or more memories and individually or collectively configured to cause the network entity to:
receive a request for authentication of a group of ambient Internet of Things (AIoT) devices during an AIoT operation, wherein the request includes a session identifier associated with the AIoT operation, filtering information, and a derivation parameter;
identify one or more previously authenticated AIoT devices from the group of AIoT devices based at least in part on the session identifier or the derivation parameter; and
authenticate one or more AIoT devices from the group of AIoT devices other than the identified one or more previously authenticated AIoT devices.

2. The network entity of claim 1, wherein the request for authentication includes multiple response parameters (RES_{AIOT}) and corresponding derivation parameters (RAND_{AIOT_d}) for multiple AIOT devices, and wherein the one or more processors are individually or collectively configured to cause the network entity to authenticate the multiple AIoT devices in a single authentication operation.

3. The network entity of claim 2, wherein, for each received RES_{AIOT_d} and corresponding RAND_{AIOT_d}, the one or more processors are individually or collectively configured to cause the network entity to:
compute expected response values (XRES_{AIOT}) for one or more candidate AIOT devices;
compare each RES_{AIOT_d} with the computed XRES_{AIOT} values; and
return information only identifying AIoT devices for which a match is found based on the comparison.

4. The network entity of claim 1, wherein, to identify the one or more previously authenticated AIoT devices, the one or more processors are individually or collectively configured to cause the network entity to:
transmit a query request to a unified data repository (UDR), wherein the query request comprises the session identifier and the derivation parameter; and
receive, from the UDR, a query response that indicates one or more authenticated AIoT devices, wherein the one or more authenticated AIoT devices includes the one or more previously authenticated AIoT devices from the group of AIOT devices.

5. The network entity of claim 4, wherein, to identify the one or more previously authenticated AIoT devices, the one or more processors are individually or collectively configured to cause the network entity to:
determine, based at least in part on the session identifier and the derivation parameter, whether a group authentication cache entry exists for the group of AIOT devices in a cache associated with the UDR.

6. The network entity of claim 5, wherein, in response to an absence of the group authentication cache entry for the group of AIoT devices in the cache associated with the UDR, the one or more processors are individually or collectively configured to cause the network entity to:
create the group authentication entry for an inventory procedure associated with the group of AIOT devices,
wherein the group authentication cache entry includes a new session identifier and timing information for retaining the group authentication cache entry.

7. The network entity of claim 6, wherein the timing information for retaining the group authentication cache entry is based at least in part on a number of AIoT devices of the group of AIoT devices or the inventory procedure.

8. The network entity of claim 1, wherein the session identifier is derived at least in part on the filtering information.

9. The network entity of claim 1, wherein the network entity is an AIoT data management (ADM) entity.

10. A network entity for wireless communication, comprising:
one or more memories; and
one or more processors coupled with the one or more memories and individually or collectively configured to cause the network entity to:
receive a request to perform an inventory procedure using a group of ambient Internet of Things (AIoT) devices;
identify, via a cache locally stored at the network entity, a list of previously authenticated AIoT devices from the group of AIoT devices; and
transmit, to an AIoT data management (ADM) entity, a request to authenticate the group of AIoT devices excluding the list of previously authenticated AIoT devices.

11. The network entity of claim 10, wherein the request to authenticate the group of AIoT devices includes multiple response parameters (RES_{AIOT_d}) and corresponding derivation parameters (RAND_{AIOT_d}) for multiple AIoT devices.

12. The network entity of claim 10, wherein the network entity is an AIoT function (AIoTF).

13. A method performed by a network entity, the method comprising:
receiving a request for authentication of a group of ambient Internet of Things (AIOT) devices during an AIoT operation, wherein the request includes a session identifier associated with the AIoT operation, filtering information, and a derivation parameter;
identifying one or more previously authenticated AIoT devices from the group of AIoT devices based at least in part on the session identifier and the derivation parameter; and
authenticating one or more AIoT devices from the group of AIoT devices other than the identified one or more previously authenticated AIoT devices.

14. The method of claim 13, wherein the request for authentication includes multiple response parameters (RES_{AIOT}) and corresponding derivation parameters (RAND_{AIOT_d}) for multiple AIoT devices, and wherein authenticating the one or more AIoT devices comprises authenticating the multiple AIOT devices in a single authentication operation.

15. The method of claim 14, wherein, for each received RES_{AIOT_d} and corresponding RAND_{AIOT_d}, the method further comprises:
computing expected response values (XRES_{AIOT}) for one or more candidate AIoT devices;
comparing each RES_{AIOT_d} with the computed XRES_{AIOT} values; and
returning information only identifying AIoT devices for which a match is found based on the comparison.

16. The method of claim 14, wherein identifying the one or more previously authenticated AIoT devices comprises:
transmitting a query request to a unified data repository (UDR), wherein the query request comprises the session identifier and the derivation parameter; and
receiving, from the UDR, a query response that indicates one or more authenticated AIOT devices, wherein the one or more authenticated AIoT devices includes the one or more previously authenticated AIoT devices from the group of AIOT devices.

17. The method of claim 14, wherein the session identifier is derived at least in part on the filtering information.

18. A network entity for wireless communication, comprising:
one or more memories; and
one or more processors coupled with the one or more memories and individually or collectively configured to cause the network entity to:
receive a request from a network function for a temporary identifier (T-ID) associated with a permanent identifier of an ambient Internet of Things (AIOT) device, wherein the request includes a T-ID handling type;
retrieve a T-ID record from a data repository using the permanent identifier as a key;
determine whether a T-ID exists for the AIoT device;
in response to determining that no T-ID exists and the handling type indicates a stored T-ID, provision a new T-ID; and
transmit the T-ID and the handling type to the network function for paging the AIoT device during an AIoT operation.

19. The network entity of claim 18, wherein the one or more processors are individually or collectively configured to cause the network entity to:
receive a resynchronization request that includes a resynchronization indicator;
retrieve or generating one or more alternate T-IDs, including a previous T-ID or a next T-ID, based on previously stored T-ID values in the data repository; and
transmit the one or more alternate T-IDs.

20. The network entity of claim 18, wherein the network entity is an AIoT data management (ADM) entity, the network function is an AIoT function (AIOTF), and the data repository is a unified data repository (UDR).
